(19) United States
(12) Patent Application Publication
(10) Pub. No.: US 2026/0246546 A1
(43) Pub. Date: Aug. 20, 2026

(54) METHOD AND APPARATUS FOR CALIBRATION OF INTERFERENCE CANCELLATION IN MOBILE COMMUNICATIONS

(71) Applicant: MediaTek Singapore Pte. Ltd., Singapore (SG)

(72) Inventors: Jozsef Gabor NEMETH, Cambridge (GB); Mohammed S Aleabe AL-IMARI, Cambridge (GB)

(21) Appl. No.: 19/164,268

(22) PCT Filed: Apr. 8, 2024
(86) PCT No.: PCT/CN2024/086509

§ 371 Date: Sep. 11, 2025

Related U.S. Application Data
(60) Provisional application No. 63/495,126, filed on Apr. 10, 2023.

(51) Int. Cl. H04B 17/21; H04B 7/06; H04L 5/00

(52) U.S. Cl. CPC H04B 17/21; H04B 7/0626; H04L 5/0048; H04L 5/0098

(57) ABSTRACT

Examples pertaining to calibration of interference cancellation in mobile communications are described. A user equipment (UE) transmits a request message to a network node to request a resource for calibration. The UE receives a configuration of the resource from the network node. The UE performs a calibration procedure on the resource to calibrate an interference cancellation operation. The request message identifies at least one of a duration, a periodicity and a frequency band associated with the calibration procedure.

### CROSS REFERENCE TO RELATED PATENT APPLICATION(S)

The present disclosure is part of a non-provisional application claiming the priority benefit of U.S. Patent Application No. 63/495,126, filed 10 Apr. 2023, the content of which herein being incorporated by reference in its entirety.

### TECHNICAL FIELD

The present disclosure is generally related to mobile communications and, more particularly, to calibration of interference cancellation of a communication apparatus in mobile communications.

### BACKGROUND

Unless otherwise indicated herein, approaches described in this section are not prior art to the claims listed below and are not admitted as prior art by inclusion in this section.

In wireless communication environments, wireless signals transmitted or broadcast by nodes or apparatuses in a wireless network may cause interference. In addition, for a sub-band full-duplex (SBFD) capable communication apparatus (e.g., a user equipment (UE)), the leakage of uplink (UL) transmission may contaminate its downlink (DL) reception and become an interference to the communication apparatus. Therefore, interference cancellation is an important operation to a communication apparatus in the wireless network.

Ideally, the interference cancellation needs to be accurately trained or calibrated prior to an actual symbol transmission or reception. However, in the conventional designs, the communication apparatuses may only perform opportunistic training or calibration in real wireless communication environments. For example, the calibration may take place only when a communication apparatus has something to send in uplink.

Accordingly, how to improve the calibration operation of interference cancellation becomes an important issue for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to calibration of interference cancellation with respect to a communication apparatus (e.g., a UE) and a network apparatus (e.g., a network node or a base station (BS), such as a next generation Node B (gNB)) in mobile communications.

In one aspect, a method may involve a communication apparatus transmitting a request message to a network node to request a resource for calibration. The method may also involve the communication apparatus receiving a configuration of the resource from the network node. The method may further involve the communication apparatus performing a calibration procedure on the resource to calibrate an interference cancellation operation.

In one aspect, a method may involve a network node receiving a request message to request a resource for calibration from a communication apparatus. The method may also involve the network node determining the resource based on the request message. The method may further involve the network node transmitting a configuration of the resource to the communication apparatus.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example communication system in accordance with an implementation of the present disclosure.

FIG. 6 is a flowchart depicting an example process in accordance with an implementation of the present disclosure.

FIG. 7 is a flowchart depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to calibration of an interference cancellation operation of a communication apparatus, especially a SBFD capable communication apparatus. According to the present disclosure, a number of possible solutions may be implemented separately or jointly. That is, although these possible solutions may be described below separately, two or more of these possible solutions may be implemented in one combination or another.

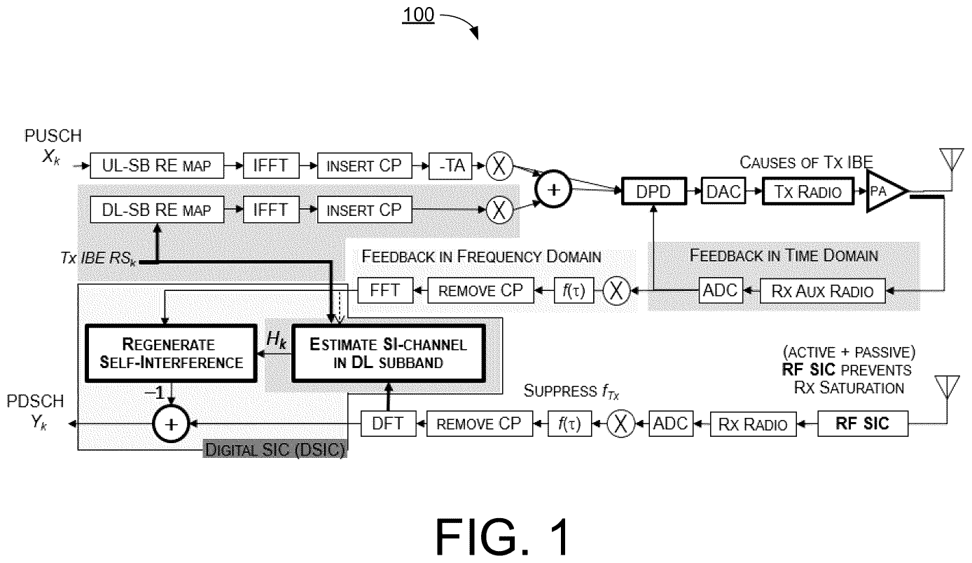

FIG. 1 illustrates an example scenario 100 under schemes in accordance with implementations of the present disclosure. Scenario 100 illustrates the exemplary signal processing in a transmission chain (Tx chain, shown in the upper portion) of a communication apparatus, and the exemplary signal processing with interference cancellation in a receiving chain (Rx chain, shown in the lower portion) of the communication apparatus.

In the Tx chain, the transmission signal (e.g., the Tx signal Xₖ) may be mapped to uplink sub-band (UL-SB) resource element (RE) and inverse fast Fourier transformed (IFFT). The cyclic prefix (CP) may be inserted and a timing advance (TA) may be applied to the Tx signal as well. The transmission signal may further undergo digital pre-distortion (DPD), digital to analog conversion (DAC), analog front-end signal processing (e.g., by the Tx radio) and gain adjustment (e.g., by the power amplifier (PA)) before being transmitted.

In an event that the communication apparatus is a SBFD capable communication apparatus, the communication apparatus has to deal with the interference from its UL transmission to its DL reception (e.g., the UL-to-DL interference, which is also named as the self-interference (SI)).

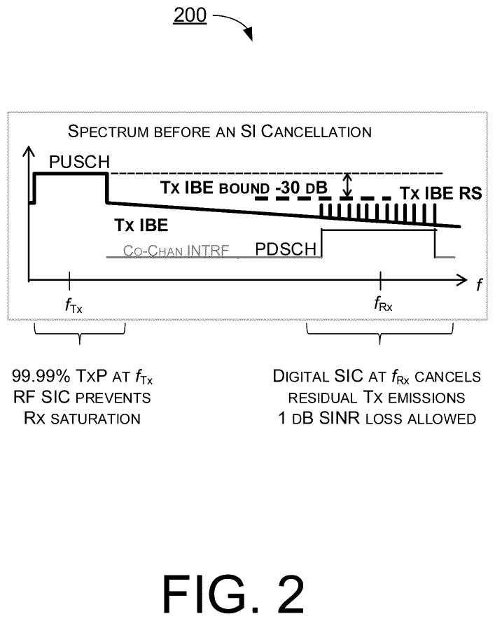

FIG. 2 illustrates an example scenario 200 under schemes in accordance with implementations of the present disclosure. Scenario 200 illustrates a power density spectrum before an SI cancellation is performed. The UE may perform a UL transmission (e.g., on a physical uplink shared channel (PUSCH)) and a DL reception (e.g., on a physical downlink shared channel (PDSCH)) in overlapped time duration. Specifically, the UE may transmit the PUSCH in the transmission bandwidth (TxBW) with a central frequency at f_{Tx} and receive the PDSCH in the reception bandwidth (RxBW) with a central frequency at f_{Rx}.

Scenario 200 further illustrates that the leakage of UL transmission may start higher at the transmission bandwidth TxBW and keep decreasing through the frequency bandwidth between the UL transmission and the DL reception. The leakage of UL transmission may finally contaminate the DL reception and generate an unwanted transmission (Tx) in-band emission (Tx IBE). Thus, it is desired that the Tx IBE can be attenuated or cancelled to avoid overloading the receiver and/or affecting the DL reception.

In some implementations, the UE may superpose at least one reference signal (RS), such as a pilot tone or a pilot signal over the original UL signal. In some implementations, the reference signal may be a wideband pilot and may sample the bandwidth of the DL signal of interest, such as the Tx IBE RS illustrated in FIG. 2. The superposed reference signal may be utilized in self-interference cancellation (SIC) (including the training or calibration of the interference cancellation or the training or calibration of the SIC).

Referring to FIG. 1, the radio frequency self-interference cancellation (RF SIC) may be performed first in the Rx chain. After the RF SIC, the receiving signal may undergo analog front-end signal processing (e.g., by the Rx radio) and analog to digital conversion (ADC) before a frequency conversion (e.g., by the mixer). After suppressing the signal components at the frequency f_{Tx}, removing the CP and performing the digital Fourier transform (DFT), the signal is provided to the digital SIC (DSIC) for a subsequent interference cancellation.

In some implementations, a feedback path from the Tx chain to the Rx chain may be provided, to assist the SI channel estimation and SI regeneration in the DSIC. In some implementations, a model may be involved in the DSIC to regenerate the self-interference. In some implementations, the interference cancellation operation has to be well trained or calibrated to accurately perform interference cancellation.

In some implementations, the interference cancellation, such as SIC, may be trained or calibrated prior to symbol of concurrent UL transmission and DL reception. The calibration (or training) may be scheduled periodic or aperiodic. The calibration (or training) may also comprise on-the-fly calibration or on-the-fly training while DL is suspended or not yet started, and fine-tracking e.g., during UL repetitions.

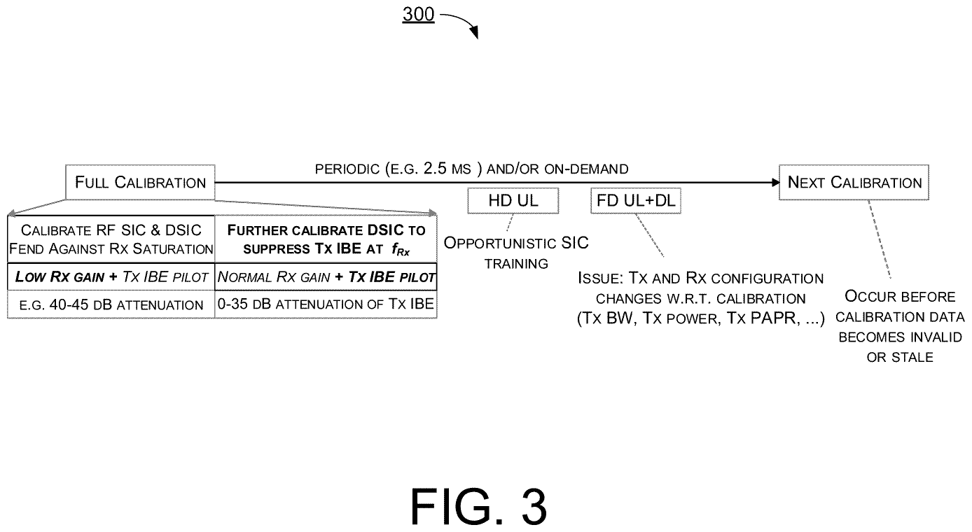

FIG. 3 illustrates an example scenario 300 under schemes in accordance with implementations of the present disclosure. A full calibration may be performed before actual UL transmission or DL reception. The RF SIC or both the RF SIC and DSIC may be calibrated first. To fend against Rx saturation, a low Rx gain may be utilized. In addition, a reference signal or a Tx IBE pilot signal, such as the Tx IBE reference signal Tx IBE RS_{K} illustrated in FIG. 1 or the Tx IBE RS illustrated in FIG. 2, may be transmitted by the UE to facilitate channel estimation.

The DSIC may be further calibrated with a normal Rx gain to suppress the Tx IBE at the frequency f_{Rx}. An on-the-fly training, which may be an opportunistic SIC training, may be carried out during half-duplex (HD) UL transmission. When the UE is in the full-duplex (FD) mode, e.g., the UL information transmitting and DL information receiving are overlapping in time, the UE may continue to track the interference, and to determine whether the Tx and Rx configuration changes and/or whether the calibration data obtained in a previous calibration procedure becomes invalid or stale. A next calibration may be performed based on the periodicity or on-demand (e.g., when the calibration data becomes invalid or stale).

In some implementations, an effective training may be allowed by muting or cancelling known interfering signals. In addition, the calibration may employ hardware reconfigurations when it does not require sending UL signal and/or receiving DL signal.

In some implementations, the communication apparatus (e.g., the UE) may inform the network node of its resource requirements for calibration. More specifically, in some implementations, the UE may transmit a request message to a network node to request a resource for calibration, receive a configuration of the resource from the network node and perform a calibration procedure on the resource to calibrate an interference cancellation operation.

In some implementations, the UE may specify a set of requirements for resources that are restricted to the UL sub-band and a separate set of requirements for resources that span the frequency sub-band of the reception (as well).

In some implementations, the request message may identify at least one of a duration, a periodicity and a frequency band associated with the calibration procedure. In some implementations, the UE may report spectral resources required by calibration, and the required spectral resources may depend on UE's implementation (e.g., duration, power level, etc. associated with the calibration) and channel conditions. Note that the channel conditions may vary per UE.

In some implementations, the UE may specify a desired duration of the calibration procedure that needs to be covered by the resource. In some implementations, the UE may specify a desired periodicity of the calibration that needs to be covered by the resource.

In some implementations, the request message may request the resource to be scheduled before a DL reception or a UL transmission of the UE. In some implementations, the UE may request the calibration or the resource for the calibration preceding the actual transmission that starts during a concurrent reception. In some implementations, the maximum time separation between the resource and the UL transmission may be predefined (e.g. as a number of symbols). In some implementations, the maximum time separation between the resource and the UL transmission may depend on the SI channel conditions of the UE.

In some implementations, the calibration procedure may be performed during a UL transmission while a concurrent DL reception is suspended or during a UL transmission overlapping with a concurrent DL reception in time. In some implementations, the calibration procedure may be performed during UL repetitions overlapping with concurrent DL reception in time. In some implementations, the calibration procedure may be performed at the start of UL transmission while concurrent DL reception is suspended.

In some implementations, the calibration procedure may be performed aperiodically or opportunistically on the resources detected by UE and/or using network assistance. In some implementations, more resources are specified for one-off aperiodic calibration (e.g., SIC training) than for periodic calibration.

In some implementations, the resource configured by the network node may comprise one or more resources allocated for a sounding reference signal (SRS), a pilot signal or a pilot tone, such as the Tx IBE RS, a channel state information (CSI) for interference measurement (IM) (CSI-IM), a non-zero-power (NZP) reference signal (RS) or a zero-power (ZP) RS.

In some implementations, the calibration may employ special training signals, e.g. SRS, in UL sub-band or in DL sub-band scheduled by gNB or a Tx IBE pilot signal. The Tx IBE pilot signal may be a wideband pilot signal transmitted by the UE in UL sub-band or in the DL sub-band below the Tx IBE mask or the Tx IBE bound, to support wideband SI-channel estimation. The spectral resources required by calibration may depend on UE's implementation and channel conditions.

In some implementations, the resource allocated for SIC calibration (e.g., SIC training) may include training-SRS that the UE transmits and CSI-IM, or other zero-power RS where DL or UL transmissions are rate-matched around. In some implementations, the “training-SRS” may refer to: the SRS (or other existing RS) reused for calibration or new RS introduced for calibration. In some implementations, the CSI-IM in UL sub-band may cause CP-OFDMA transmission be rate-matched around.

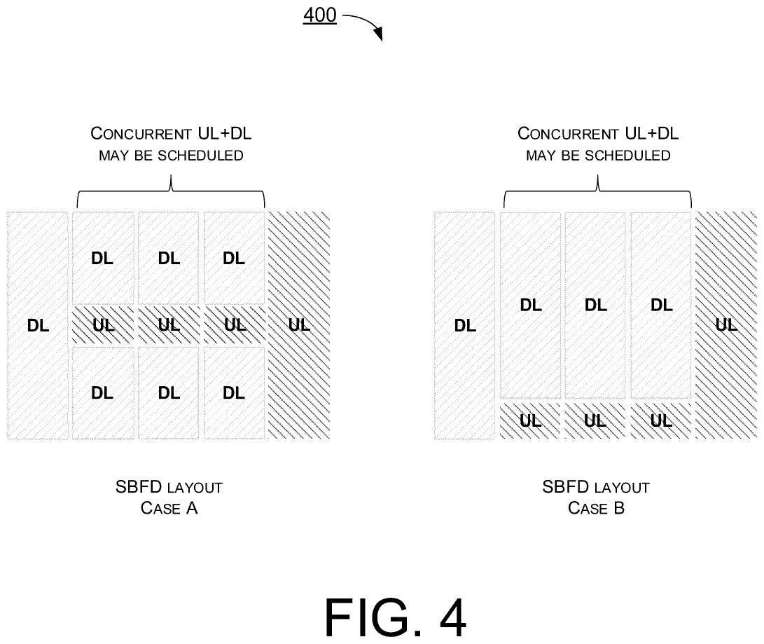

FIG. 4 illustrates an example scenario under schemes in accordance with implementations of the present disclosure. Scenario 400 illustrates two exemplary cases of SBFD layout. The time-frequency resources may be allocated for DL or UL. Certain symbols may also be flexible, or potentially, scheduling may override the UL sub-band. The difference between SBFD case A and SBFD case B is that in case B, the DL sub-band is a contiguous region.

In some implementations, the SI channel estimation may be performed in either the UL sub-band or the DL sub-band at a lowered Tx power. The internal calibration of receiver may be implemented at extremely low Tx emission. Adaptation of DPD or any Tx nonlinearity model may be performed at a normal Tx power.

In some implementations, the allocation of SRS or training-RS is not restricted to UL-only symbol or UL sub-band. In some implementations, the SRS may be allowed to overlap with DL sub-band, and may be allowed or not allowed to be transmitted in DL-only symbol. In some implementations, the SRS allocated for SIC training may be allowed to overlap with DL sub-band or may be transmitted in a DL-only symbol.

In some implementations, the power level of SRS transmitted in a DL-only symbol or a DL sub-band may be independent of UL transmit power control (TPC). A new SRS attribute or a new pre-defined bound may define the SRS power level. In some implementations, the power level of SRS transmitted in a UL-only symbol or a UL sub-band may be selected to be independent of UL TPC. A new SRS attribute or a new pre-defined bound may define the SRS power level.

In some implementations, special reference signals may be introduced for the purpose of SIC training. In some implementations, the SRS transmitted in a DL-only symbol or a DL sub-band may not collide with a demodulation reference signal (DMRS) or a channel state information reference signal (CSI-RS) configured to the UE. In some implementations, the SRS transmitted in a DL-only symbol or a DL sub-band may not overlap in time and frequency with any DL reception by the UE. In some implementations, the SRS transmitted in a DL-only symbol or a DL sub-band may not overlap in time with any DL reception by the UE.

In some implementations, the resource element (RE) (e.g., a DL RE) where the UE's reception would overlap in frequency and in time with a scheduled SRS or training-RS may be muted. In some implementations, the location of the muted RE may be signalled to the UE and it may be left to UE implementation to use these resources to transmit training-RS below the Tx IBE bound.

In some implementations, in the performing of the calibration procedure on the resource, the UE may transmit the SRS or the pilot signal in a DL sub-band or a DL symbol configured to the UE and perform interference measurement based on the SRS or the pilot signal. In some implementations, the SRS or the pilot signal may be transmitted in a low power. For example, a power level of the SRS or the pilot signal may be not higher than a predefined threshold.

In some implementations, in the performing of the calibration procedure on the resource, the UE may transmit the SRS or the pilot signal in an uplink sub-band or an uplink symbol configured to the UE and perform interference measurement based on the SRS or the pilot signal.

In some implementations, the timing advance (TA) used with training-SRS may be different from the timing advance used with signals and channels used in the UL.

In some implementations, in the performing of the calibration procedure on the resource, the UE may perform interference measurement based on the resources allocated for the CSI-IM, the NZP RS or the ZP RS.

In some implementations, in the performing of the calibration procedure on the resource, the UE may perform a channel estimation of the SI channel according to a measurement performed on the resource, determine calibration data of a model in the interference cancellation operation which models the SI channel based on the channel estimation, and determine whether the calibration data is valid.

In some implementations, the UE may transmit a report to the network node to report at least one of a Doppler level, a time coherence and a parameter associated with the self-interference channel in an event that the calibration data becomes invalid or stale. The Doppler level, the time coherence of the SI channel and the parameter may indicate when the calibration data becomes invalid or stale. In some implementations, the report may be comprised in a measurement report (e.g., as a part of a channel quality indicator (CQI) report) or a medium access control (MAC) control element (CE).

In some implementations, the UE may report the potential improvement in link quality that it expects from calibration to the network node. The network node may determine whether calibration should take place based on the report. In some implementations, the UE may report as an improvement in the predicted signal-to-interference-plus-noise ratio (SINR) or CQI of the full-duplex operation. In some implementations, the UE may report the potential improvement in link quality as an improvement in the predicted admissible transmit power (ATP) of the full-duplex operation, which is the maximum power level for which the SINR target can be met with confidence.

With respect to the network node, in some implementations, the network node may receive a request message to request a resource for calibration from a communication apparatus (e.g., a UE), determine the resource based on the request message and transmit a configuration of the resource to the UE.

In some implementations, the request message may identify at least one of a duration, a periodicity and a frequency band associated with a calibration procedure to be performed by the UE, and wherein at least one of a duration, a periodicity and a frequency band of the resource covers the duration, the periodicity and the frequency band associated with the calibration procedure.

In some implementations, the network node may grant the resource to UE per trigger condition. In some implementations, the triggers may be categorized as periodic, aperiodic, on-the-fly, opportunistic, or fine-tracking.

In some implementations, the network node may schedule one or more resources for transmission and/or measurement during calibration. In some implementations, the resource may be configured with a time offset and a periodicity (for example, as in the case of periodic SRS), or configured with a repetition number or a duration.

In some implementations, semi-persistent resources may be enabled and or disabled by dynamic signaling. In some implementations, aperiodic resource may be triggered by dynamic signaling.

In some implementations, the resource may be scheduled before a downlink activity or an uplink activity of the UE, or scheduled relative to a scheduled uplink allocation of the UE.

In some implementations, resource for on-the-fly calibration may be triggered relative to any UL allocation that is scheduled in the future concurrently with reception. In some implementations, the resource may be applicable with UL transmission that starts during a concurrent DL reception.

In some implementations, resource for opportunistic calibration may be triggered by events detected by the UE. In some implementations, the network node may configure at least one condition for an event to trigger a calibration procedure or a power level applicable with a transmission of the UE on the resource.

In some implementations, the condition may be pre-defined in the standard when the UE can trigger an opportunistic calibration. For example, the received signal strength indicator (RSSI) measured per physical resource block (PRB) or a group of PRBs may need to be below a threshold. In some implementations, the network node may configure the power level applicable with opportunistic SRS-training transmission.

In some implementations, the network node may mute an RE associated with the communication apparatus in an event that the resource element overlaps the resource in time domain, for example, where the UE's reception would overlap in frequency and in time with a scheduled SRS or training-RS. In some implementations, the network node may transmit information regarding a location of a muted resource element to the communication apparatus.

In some implementations, the network node may learn that an opportunistic SIC calibration has taken and calibration data is updated from reports on SINR loss, CQI, ATP. In some implementations, the opportunistic calibration may be restricted to durations where the UE is transmitting in the UL. In some implementations, the opportunistic calibration may take place also when the UE is not transmitting in UL.

In some implementations, the resource in tracking mode may be triggered by full-duplex UL transmission and DL reception of the UE. In some implementations, the UE may report its requirements vis-a-vis the abovementioned categories of resource separately.

In some implementations, in an event that the calibration (or SIC training) (or respective resource) overlaps in time and frequency with other UE's DL reception, the network node may share the information necessary for the cancelation of the signals that interfere with the calibration. In some implementations, network assisted interference cancellation (NAIC) of intra-cell DL or UL during the calibration may be performed in an event that no measurement resource is available.

In some implementations, the network node may transmit assistance information associated with another communication apparatus to the UE. In some implementations, the assistance information may comprise at least one of a configuration of a reference signal, a frequency domain resource allocation (FDRA) and a modulation and coding scheme (MCS). In some implementations, the reference signal may comprise at least one of a DMRS, an SRS and a CSI-RS.

In some implementations, the UE may receive the assistance information associated with another apparatus from the network node, where the assistance information may comprise at least one of a configuration of a reference signal, a FDRA and an MCS, and the UE may cancel an interference signal received during the calibration procedure based on the assistance information.

In some implementations, the UE may cancel the DMRS, the SRS or the CSI-RS. In some implementations, in an event that the MCS of the interfering signal is high enough for robust demodulation, the UE may attempt to cancel the resources carrying as well.

### Illustrative Implementations

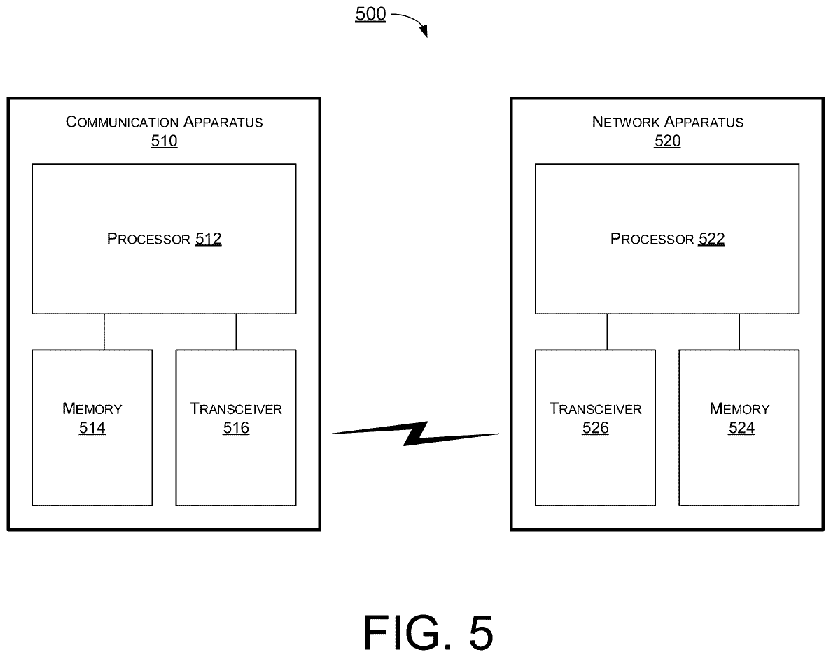

FIG. 5 illustrates an example communication system 500 having an example communication apparatus 510 and an example network apparatus 520 in accordance with an implementation of the present disclosure. Each of the communication apparatus 510 and the network apparatus 520 may perform various functions to implement schemes, techniques, processes and methods described herein pertaining to calibration of an interference cancellation operation of a communication apparatus, including scenarios/schemes described above as well as the processes 600 and the process 700 described below.

Communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

In one aspect, each of the processor 512 and the processor 522 may be implemented in the form of one or more single-core processors, one or more multi-core processors, or one or more CISC processors. That is, even though a singular term “a processor” is used herein to refer to the processor 512 and the processor 522, each of the processor 512 and the processor 522 may include multiple processors in some implementations and a single processor in other implementations in accordance with the present disclosure. In another aspect, each of the processor 512 and the processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512 and the processor 522 is a special-purpose machine specifically designed, arranged and configured to perform specific tasks including autonomous reliability enhancements in a device (e.g., as represented by communication apparatus 510) and a network (e.g., as represented by network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may have a plurality of physical antennas which associates with a plurality of antenna ports. In some implementations, the network apparatus 520 may further include a memory 524 coupled to processor 522 and capable of being accessed by the processor 522 and storing data therein. Accordingly, communication apparatus 510 and the network apparatus 520 may wirelessly communicate with each other via the transceiver 516 and the transceiver 526, respectively. To aid better understanding, the following description of the operations, functionalities and capabilities of each of the communication apparatus 510 and the network apparatus 520 is provided in the context of a mobile communication environment in which the communication apparatus 510 is implemented in or as an apparatus or a UE and the network apparatus 520 is implemented in or as a network node or a network device of a communication network.

In some implementations, the processor 512 of the communication apparatus 510 may transmit, via the transceiver 516, a request message to a network node (e.g., the network apparatus 520) to request a resource for calibration. The processor 512 may receive, via the transceiver 516, a configuration of the resource from the network node and perform a calibration procedure on the resource to calibrate an interference cancellation operation.

In some implementations, the request message may identify at least one of a duration, a periodicity and a frequency band associated with the calibration procedure.

In some implementations, the request message may request the resource to be scheduled before a downlink reception or an uplink transmission of the communication apparatus 510.

In some implementations, the calibration procedure may be performed during an uplink transmission while a concurrent downlink reception is suspended or during an uplink transmission overlapping with a concurrent downlink reception in time.

In some implementations, the resource configured by the network node may comprise one or more resources allocated for an SRS, a pilot signal, a CSI-IM, an NZP RS or a ZP RS.

In some implementations, in the performing of the calibration procedure on the resource, the processor 512 may transmit, via the transceiver 516, the SRS or the pilot signal in a downlink sub-band or a downlink symbol configured to the communication apparatus 510 and perform interference measurement based on the SRS or the pilot signal. In some implementations, a power level of the SRS or the pilot signal may be not higher than a predefined threshold.

In some implementations, in the performing of the calibration procedure on the resource, the processor 512 may transmit, via the transceiver 516, the SRS or the pilot signal in an uplink sub-band or an uplink symbol configured to the communication apparatus 510 and perform interference measurement based on the SRS or the pilot signal.

In some implementations, in the performing of the calibration procedure on the resource, the processor 512 may perform interference measurement based on the resources allocated for the CSI-IM, the NZP RS or the ZP RS.

In some implementations, in the performing of the calibration procedure on the resource, the processor 512 may perform a channel estimation of a self-interference channel according to a measurement performed on the resource, determine calibration data of a model in the interference cancellation operation which models the self-interference channel based on the channel estimation and determining whether the calibration data is valid. In some implementations, the processor 512 may transmit, via the transceiver 516, a report to the network node to report at least one of a Doppler level, a time coherence and a parameter associated with the self-interference channel in an event that the calibration data becomes invalid.

In some implementations, the report may be comprised in a measurement report or a MAC-CE.

In some implementations, the processor 512 may receive, via the transceiver 516, assistance information associated with another apparatus from the network node and cancel an interference signal received during the calibration procedure based on the assistance information. In some implementations, the assistance information may comprise at least one of a configuration of a reference signal, an FDRA and an MCS.

In some implementations, the processor 522 of the network apparatus 520 may receive, via the transceiver 526, a request message to request a resource for calibration from a communication apparatus (e.g., the communication apparatus 510), determine the resource based on the request message and transmit, via the transceiver 526, a configuration of the resource to the communication apparatus.

In some implementations, the request message may identify at least one of a duration, a periodicity and a frequency band associated with a calibration procedure to be performed by the communication apparatus, and at least one of a duration, a periodicity and a frequency band of the resource may cover the duration, the periodicity and the frequency band associated with the calibration procedure.

In some implementations, the resource may be configured with a time offset and a periodicity, or configured with a repetition number or a duration.

In some implementations, the resource may be scheduled before a downlink activity or an uplink activity of the communication apparatus, or scheduled relative to a scheduled uplink allocation of the communication apparatus.

In some implementations, the processor 522 may mute a resource element associated with the communication apparatus in an event that the resource element overlaps the resource in time domain.

In some implementations, the processor 522 may transmit, via the transceiver 526, information regarding a location of a muted resource element to the communication apparatus.

In some implementations, the processor 522 may configure at least one condition for an event to trigger a calibration procedure or a power level applicable with a transmission of the communication apparatus on the resource.

In some implementations, the processor 522 may transmit, via the transceiver 526, assistance information associated with another communication apparatus to the communication apparatus. In some implementations, the assistance information may comprise at least one of a configuration of a reference signal, an FDRA and an MCS.

In some implementations, the reference signal may comprise at least one of a DMRS and a CSI-RS.

### Illustrative Processes

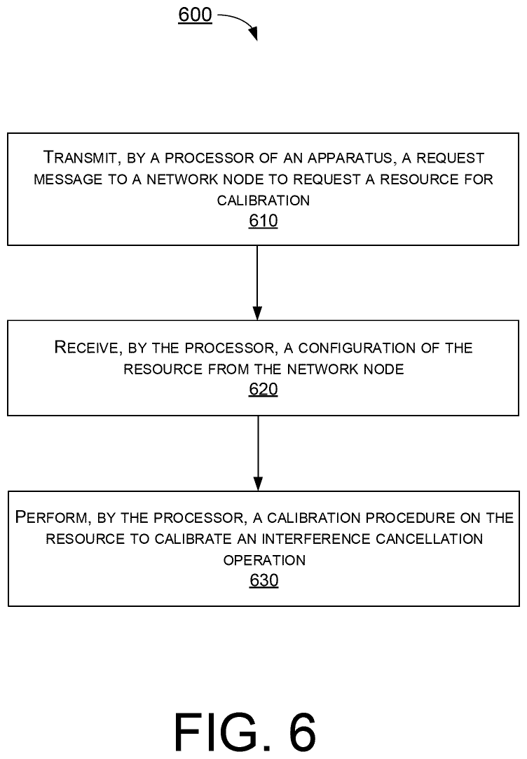

FIG. 6 illustrates an example process 600 in accordance with an implementation of the present disclosure. The process 600 may be an example implementation of above scenarios/schemes, whether partially or completely, with respect to calibration of interference cancellation in accordance with the present disclosure. The process 600 may represent an aspect of implementation of features of the communication apparatus 510. The process 600 may include one or more operations, actions, or functions as illustrated by one or more of blocks 610, 620 and 630. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices. Solely for illustrative purposes and without limitation, the process 600 is described below in the context of the communication apparatus 510. The process 600 may begin at block 610.

At 610, the process 600 may involve the processor 512 of the communication apparatus 510 transmitting a request message to a network node (e.g., the network apparatus 520) to request a resource for calibration. The process 600 may proceed from 610 to 620.

At 620, the process 600 may involve the processor 512 receiving a configuration of the resource from the network node. The process 600 may proceed from 620 to 630.

At 630, the process 600 may involve the processor 512 performing a calibration procedure on the resource to calibrate an interference cancellation operation.

In some implementations, the request message may identify at least one of a duration, a periodicity and a frequency band associated with the calibration procedure.

In some implementations, the request message may request the resource to be scheduled before a downlink reception or an uplink transmission of the communication apparatus 510.

In some implementations, the calibration procedure may be performed during an uplink transmission while a concurrent downlink reception is suspended or during an uplink transmission overlapping with a concurrent downlink reception in time.

In some implementations, the resource configured by the network node may comprise one or more resources allocated for an SRS, a pilot signal, a CSI-IM, an NZP RS or a ZP RS.

In some implementations, in the performing of the calibration procedure on the resource, the process 600 may involve the processor 512 transmitting the SRS or the pilot signal in a downlink sub-band or a downlink symbol configured to the communication apparatus 510 and performing interference measurement based on the SRS or the pilot signal. In some implementations, a power level of the SRS or the pilot signal may be not higher than a predefined threshold.

In some implementations, in the performing of the calibration procedure on the resource, the process 600 may involve the processor 512 transmitting the SRS or the pilot signal in an uplink sub-band or an uplink symbol configured to the communication apparatus 510 and perform interference measurement based on the SRS or the pilot signal.

In some implementations, in the performing of the calibration procedure on the resource, the process 600 may involve the processor 512 performing interference measurement based on the resources allocated for the CSI-IM, the NZP RS or the ZP RS.

In some implementations, in the performing of the calibration procedure on the resource, the process 600 may involve the processor 512 performing a channel estimation of a self-interference channel according to a measurement performed on the resource, determining calibration data of a model in the interference cancellation operation which models the self-interference channel based on the channel estimation and determining whether the calibration data is valid. In some implementations, the process 600 may involve the processor 512 transmitting a report to the network node to report at least one of a Doppler level, a time coherence and a parameter associated with the self-interference channel in an event that the calibration data becomes invalid.

In some implementations, the report may be comprised in a measurement report or a MAC-CE.

In some implementations, the process 600 may involve the processor 512 receiving assistance information associated with another apparatus from the network node and cancelling an interference signal received during the calibration procedure based on the assistance information. In some implementations, the assistance information may comprise at least one of a configuration of a reference signal, an FDRA and an MCS.

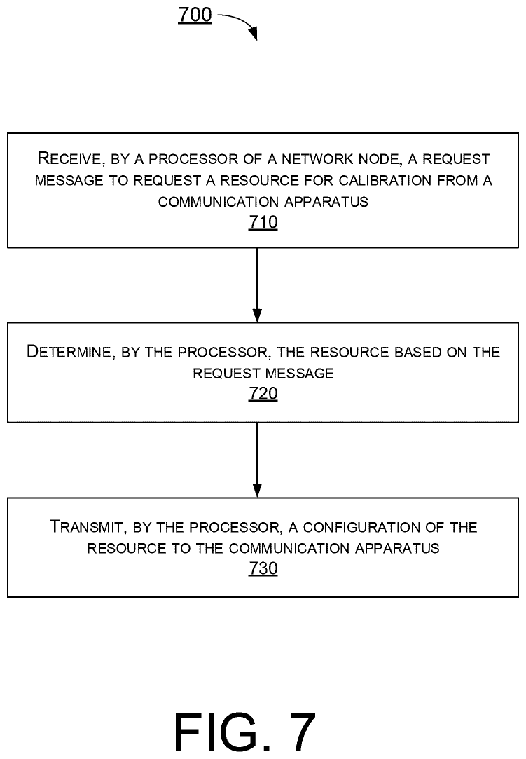

FIG. 7 depicting an example process 700 in accordance with an implementation of the present disclosure. The process 700 may be an example implementation of above scenarios/schemes, whether partially or completely, with respect to calibration of interference cancellation in accordance with the present disclosure. The process 700 may represent an aspect of implementation of features of the network apparatus 520. The process 700 may include one or more operations, actions, or functions as illustrated by one or more of blocks 710, 720 and 730. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the network apparatus 520 or any suitable network device or network node. Solely for illustrative purposes and without limitation, the process 700 is described below in the context of the network apparatus 520. The process 700 may begin at block 710.

At 710, the process 700 may involve the processor 522 of the network apparatus 520 receiving a request message to request a resource for calibration from a communication apparatus (e.g., the communication apparatus 510). The process 700 may proceed from 710 to 720.

At 720, the process 700 may involve the processor 522 determining the resource based on the request message. The process 700 may proceed from 720 to 730.

At 730, the process 700 may involve the processor 522 transmitting a configuration of the resource to the communication apparatus.

In some implementations, the request message may identify at least one of a duration, a periodicity and a frequency band associated with a calibration procedure to be performed by the communication apparatus, and at least one of a duration, a periodicity and a frequency band of the resource may cover the duration, the periodicity and the frequency band associated with the calibration procedure.

In some implementations, the resource may be configured with a time offset and a periodicity, or configured with a repetition number or a duration.

In some implementations, the resource may be scheduled before a downlink activity or an uplink activity of the communication apparatus, or scheduled relative to a scheduled uplink allocation of the communication apparatus.

In some implementations, the process 700 may involve the processor 522 muting a resource element associated with the communication apparatus in an event that the resource element overlaps the resource in time domain.

In some implementations, the process 700 may involve the processor 522 transmitting information regarding a location of a muted resource element to the communication apparatus.

In some implementations, the process 700 may involve the processor 522 configuring at least one condition for an event to trigger a calibration procedure or a power level applicable with a transmission of the communication apparatus on the resource.

In some implementations, the process 700 may involve the processor 522 transmitting assistance information associated with another communication apparatus to the communication apparatus. In some implementations, the assistance information may comprise at least one of a configuration of a reference signal, an FDRA and an MCS.

In some implementations, the reference signal may comprise at least one of a DMRS and a CSI-RS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a request message to a network node to request a resource for calibration;
receiving, by the processor, a configuration of the resource from the network node; and
performing, by the processor, a calibration procedure on the resource to calibrate an interference cancellation operation.

2. The method of claim 1, wherein the request message identifies at least one of a duration, a periodicity and a frequency band associated with the calibration procedure.

3. The method of claim 1, wherein the request message requests the resource to be scheduled before a downlink reception or an uplink transmission of the apparatus.

4. The method of claim 1, wherein the calibration procedure is performed during an uplink transmission while a concurrent downlink reception is suspended or during an uplink transmission overlapping with a concurrent downlink reception in time.

5. The method of claim 1, wherein the resource configured by the network node comprises one or more resources allocated for a sounding reference signal (SRS), a pilot signal, a channel state information (CSI) for interference measurement (IM) (CSI-IM), a non-zero-power (NZP) reference signal (RS) or a zero-power (ZP) RS.

6. The method of claim 5, wherein the performing of the calibration procedure on the resource comprises:
transmitting, by the processor, the SRS or the pilot signal in a downlink sub-band or a downlink symbol configured to the apparatus; and
performing, by the processor, interference measurement based on the SRS or the pilot signal,
wherein a power level of the SRS or the pilot signal is not higher than a predefined threshold.

7. The method of claim 5, wherein the performing of the calibration procedure on the resource comprises:
transmitting, by the processor, the SRS or the pilot signal in an uplink sub-band or an uplink symbol configured to the apparatus; and
performing, by the processor, interference measurement based on the SRS or the pilot signal.

8. The method of claim 5, wherein the performing of the calibration procedure on the resource comprises:
performing, by the processor, interference measurement based on the resources allocated for the CSI-IM, the NZP RS or the ZP RS.

9. The method of claim 1, wherein the performing of the calibration procedure on the resource comprises:
performing, by the processor, a channel estimation of a self-interference channel according to a measurement performed on the resource;
determining, by the processor, calibration data of a model in the interference cancellation operation which models the self-interference channel based on the channel estimation; and
determining, by the processor, whether the calibration data is valid, and wherein the method further comprises:
transmitting, by the processor, a report to the network node to report at least one of a Doppler level, a time coherence and a parameter associated with the self-interference channel in an event that the calibration data becomes invalid.

10. The method of claim 9, wherein the report is comprised in a measurement report or a medium access control (MAC) control element (CE).

11. The method of claim 1, further comprising:
receiving, by the processor, assistance information associated with another apparatus from the network node, wherein the assistance information comprises at least one of a configuration of a reference signal, a frequency domain resource allocation (FDRA) and a modulation and coding scheme (MCS); and
canceling, by the processor, an interference signal received during the calibration procedure based on the assistance information.

12. A method, comprising:
receiving, by a processor of a network node, a request message to request a resource for calibration from a communication apparatus;
determining, by the processor, the resource based on the request message; and
transmitting, by the processor, a configuration of the resource to the communication apparatus.

13. The method of claim 12, wherein the request message identifies at least one of a duration, a periodicity and a frequency band associated with a calibration procedure to be performed by the communication apparatus, and wherein at least one of a duration, a periodicity and a frequency band of the resource covers the duration, the periodicity and the frequency band associated with the calibration procedure.

14. The method of claim 12, wherein the resource is configured with a time offset and a periodicity, or configured with a repetition number or a duration.

15. The method of claim 12, wherein the resource is scheduled before a downlink activity or an uplink activity of the communication apparatus, or scheduled relative to a scheduled uplink allocation of the communication apparatus.

16. The method of claim 12, further comprising:
muting, by the processor, a resource element associated with the communication apparatus in an event that the resource element overlaps the resource in time domain.

17. The method of claim 12, further comprising:
transmitting, by the processor, information regarding a location of a muted resource element to the communication apparatus.

18. The method of claim 12, further comprising:
configuring, by the processor, at least one condition for an event to trigger a calibration procedure or a power level applicable with a transmission of the communication apparatus on the resource.

19. The method of claim 12, further comprising:
transmitting, by the processor, assistance information associated with another communication apparatus to the communication apparatus,
wherein the assistance information comprises at least one of a configuration of a reference signal, a frequency domain resource allocation (FDRA) and a modulation and coding scheme (MCS).

20. The method of claim 19, wherein the reference signal comprises at least one of a demodulation reference signal (DMRS) and a channel state information reference signal (CSI-RS).
